(19) United States
(12) Patent Application Publication
(10) Pub. No.: US 2026/0299972 A1
(43) Pub. Date: Oct. 1, 2026

(54) AUTOMATED CONTEXTUAL INSIGHTS FOR ON-SCREEN VISUAL CONTENT

(71) Applicant: MICROSOFT TECHNOLOGY LICENSING, LLC, Redmond, WA (US)

(72) Inventors: Medhaj Suresh ATHILKAR, Seattle, WA (US); Yan YAN, San Francisco, CA (US); Benjamin Bear STOLOVITZ, West Hartford, CT (US); Bryce Allen HENTHORN, Seattle, WA (US); Melinda IVANOV, Bothell, WA (US); John Joseph BUGLIONE, III, San Francisco, CA (US)

(21) Appl. No.: 19/093,967

(22) Filed: Mar. 28, 2025

(51) Int. Cl. G06F 9/451; G06F 16/953; G06V 20/50

(52) U.S. Cl. CPC G06F 9/451; G06F 16/953; G06V 20/50

(57) ABSTRACT

The techniques presented herein provide a system for proactive output of information that is relevant to the context of on-screen visual content such as text and images. Recent developments in artificial intelligence systems have enabled various user productivity tools that streamline aspects of the user experience of a computing device (e.g., a laptop, a smartphone, a tablet). However, some users may not take advantage of artificial intelligence productivity tools despite their utility due to the additional technical burden that users may find overwhelming. As such, the present system proactively extracts on-screen content via a content capture for analysis by a computational model (e.g., a generative language model) in response to a user activity trigger. Accordingly, the computational model identifies the semantic content of the content capture (e.g., the concepts and/or ideas) and follow-up information that is contextually relevant to the content capture without requiring additional input from the user.

### BACKGROUND

From completing assignments for work and school to planning vacations or online shopping, more of modern life occurs through computing devices. As such, a user may utilize a diverse array of software applications to accomplish various tasks. Moreover, a given software application can be transformed by different contexts. For instance, an internet browser can be utilized to look up nearby restaurants at one moment and research information for a presentation at another moment. Consequently, the user may lose track of what they were doing at a given moment as well as the context of that activity. To aid users in retracing their steps, many software applications include features for searching and retrieving content and/or activity, such as the browsing history in an internet browser and/or a listing of recent files in a file explorer.

However, the aforementioned features lack the ability to record context and decipher user intent. For example, a user may attempt a keyword search to recover a source of information for citation in a presentation. Unfortunately, the lack of specificity in existing approaches may prevent the user from finding the information for which they are looking. Moreover, the aforementioned features place an additional burden on the user to remember exact details about their past activity such as the name of a website, title of an article, or other information. Manual search and/or recollection can be especially challenging due to the volume of information the user generates and interacts with on a daily basis. That is, many existing systems place the onus on the user to spend time manually organizing, categorizing, and documenting information rather than accomplishing the tasks they wish to complete.

It is with respect to these and other considerations that the disclosure made herein is presented.

### SUMMARY

The techniques presented herein provide a system for proactive output of information that is relevant to the context of on-screen visual content such as text and images. As mentioned above, more of modern life occurs digitally with users engaging in hundreds or even thousands of interactions on a daily basis across many applications (e.g., web browsers, file managers, music players) and content (e.g., web pages, documents, audiovisual files). Consequently, the volume of activity and available content can be overwhelming to many users. Moreover, many users may struggle to effectively organize and/or navigate their past activity (e.g., web browsing history) leading to time and effort wasted searching for and/or retrieving content.

To that end, recent developments in artificial intelligence (AI) systems have enabled various user productivity tools that streamline various aspects of the user experience of a computing device (e.g., a laptop, a smartphone, a tablet). In one example, a system periodically collects, with the consent of the user, a record of user activity such as a content capture (e.g., a screenshot) of a desktop environment. In a more specific example, the system collects a content capture once every defined time period (e.g., sixty seconds) and/or once a threshold amount of desktop content has changed. The content capture is then processed by a computational model (e.g., a multimodal generative AI model, a large language model, a small language model) to identify the semantic content of the content capture. That is, the computation model identifies semantics of on-screen information such as text and images. Moreover, a plurality of content captures can be grouped in a graphical user interface that enables users to view organized collections of content captures based on shared attributes (e.g., a common topic, a common application). In this way, content captures provide an accurate and searchable recollection of moments of interest in past user activity thereby alleviating the burden on the user to manually organize their activity history.

In another example, the computational model is invoked to process on-screen visual content to assist a user in an activity. For instance, a user drafting an email to organize a social gathering may invoke the computational model to suggest a suitable location instead of manually researching locations. However, some users may not take advantage of artificial intelligence productivity tools despite their utility. In many cases, invoking a computational model can be an additional technical burden that users may find unacceptable. For instance, users that infrequently interact with their devices may be unaware of the existence of such tools much less the process for invoking and/or utilizing them. That is, many artificial intelligence systems pose a barrier of entry that precludes many users, including those that are not technology-oriented.

The methods and systems of the present disclosure analyze on-screen content to proactively offer insights that are relevant to the user's current context. More specifically, the system extracts on-screen content via a content capture for analysis by a computational model such as a multimodal generative AI model, a large language model, or a small language model. In various examples, the content capture is a composite of visual content retrieved from one or more application windows within the desktop environment. In addition, the visual content can comprise text content, image content, audio content, multimedia content, and the like.

Consequently, the visual content conveys a semantic content of the content capture. For instance, a string of text that reads “Spanish tortilla recipe” relates to more nebulous concepts such as “Spanish food”, “cooking”, and “recipes”. That is, a concrete piece of visual content communicates semantic content that a reader (e.g., a human being) can understand but which an automated tool that merely parses the visual content cannot. Accordingly, the system automatically invokes a computational model to process the extracted visual content of the content capture to identify the semantic content present on-screen. In various examples, the computational model is automatically invoked in response to a detection of a user activity trigger. For instance, a user opening a specific application (e.g., an activity recall application, a file explorer, a screen reader) can cause the system to determine that it is an appropriate time to invoke the computational model. In another example, a user composing an email may stop typing for a threshold amount of time (e.g., five seconds) indicating that the user paused to think or search for an idea. In response, the system can invoke the computational model to process on-screen visual content and offer relevant insights. However, the user may also manually invoke and/or dismiss the computational model.

The computational model may be a language model that leverages characteristically strong language processing performance to form associations between visual content and semantic content. However, it should be understood that the computational model can be any suitable tool for processing and reasoning about visual content. In addition to identifying the semantic content, the computational model determines a follow-up input based on the semantic content of the content capture. For instance, continuing with the example of a “Spanish tortilla recipe”, a follow-up input can be “what specific ingredients are needed for a Spanish tortilla?”. More generally, a follow-up input is a request and/or a question that semantically follows from the semantic content communicated by the on-screen visual content. In various examples, the computational model is configured to output a top number (e.g., top five) follow-up inputs that that computational model determines follow most logically from the on-screen visual content.

In addition to the follow-up input, the computational model calculates an output corresponding to the follow-up input. For instance, the output corresponding to the follow-up input of “what specific ingredients are needed for a Spanish tortilla?” can be “eggs, potatoes, onion, salt, and olive oil.” That is, where the follow-up input is a request and/or a question, the corresponding output is a response that satisfies the request and/or the question. In various examples, the corresponding output is a string of text, an image, a search result, or the like. The system then proceeds to render both the follow-up input and the corresponding output in a graphical user interface (GUI) alongside the content capture of the on-screen visual content. In this way, the follow-up input and the corresponding output are presented within the context of the content capture thereby streamlining the user experience. That is, the user does not need to break their “flow” (e.g., stop their train of thought, switch applications) to search for information and/or content.

In another example of the technical benefit of the present disclosure, the system proactively invokes the computational model. That is, the end user does not need any technical knowledge or to engage in specific operations to take advantage of the computational model. As mentioned above, many users forgo the utility of artificial intelligence tools and/or an automated assistant that can quickly search for information and provide suggestions and/or insights due to the additional technical burden. That is, such users may conceptualize an artificial intelligence tool and/or assistant as yet one more feature requiring additional time and effort to learn. For instance, a user that primarily utilizes their computing device (e.g., laptop, tablet) to send emails and/or browse social media may not be aware of artificial intelligence tools and/or assistants much less utilize them in their daily activity. Consequently, a system that proactively invokes a computational model to provide contextual insights at specific moments reduces friction in the user experience especially for end users that are less technologically inclined. For instance, in the context of a user activity recall application, the system can provide insights to a user that may not have a strong understanding and/or organization of their activity history.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 illustrates an example graphical user interface for viewing automated insights within the context of a content capture depicting past user activity.

FIG. 2 illustrates an example graphical user interface for seamlessly retrieving automated suggestions during a user activity.

FIG. 3 illustrates another example graphical user interface for seamlessly retrieving automated suggestions during a user activity.

FIG. 4 is a block diagram of a system for providing contextual insights for a content capture in a graphical user interface.

FIG. 5 is a flow diagram showing aspects of a process for providing contextual insights for a content capture in a graphical user interface.

FIG. 6 is a computer architecture diagram illustrating an illustrative computer hardware and software architecture for a computing system capable of implementing aspects of the techniques and technologies presented herein.

### DETAILED DESCRIPTION

The techniques presented herein provide a system for proactive output of information that is relevant to the context of on-screen visual content such as text and images. As mentioned above, more of modern life occurs digitally with users engaging in hundreds or even thousands of interactions on a daily basis across many applications (e.g., web browsers, file managers, music players) and content (e.g., web pages, documents, audiovisual files). Consequently, the volume of activity and available content can be overwhelming to many users. Moreover, many users may struggle to effectively organize and/or navigate their past activity (e.g., web browsing history) leading to time and effort spent searching for and/or retrieving content.

In contrast, the methods and systems of the present disclosure analyze on-screen content to proactively offer insights that are relevant to the user's current context. More specifically, the system extracts on-screen content via a content capture for analysis by a computational model such as a multimodal generative artificial intelligence (AI) model, a large language model, or a small language model. In various examples, the content capture is a composite of visual content retrieved from one or more application windows within the desktop environment. In addition, the visual content can comprise text content, image content, audio content, multimedia content, and the like. Moreover, the content capture may include visual content that is not directly visible on screen. For instance, a user may be viewing a webpage that extends past the bounds of the display of their computing device (e.g., a laptop screen). Nonetheless, the computing device has retrieved the full webpage when the user navigated to the webpage. Consequently, the content capture can include the full visual content of the webpage (e.g., an extended screenshot).

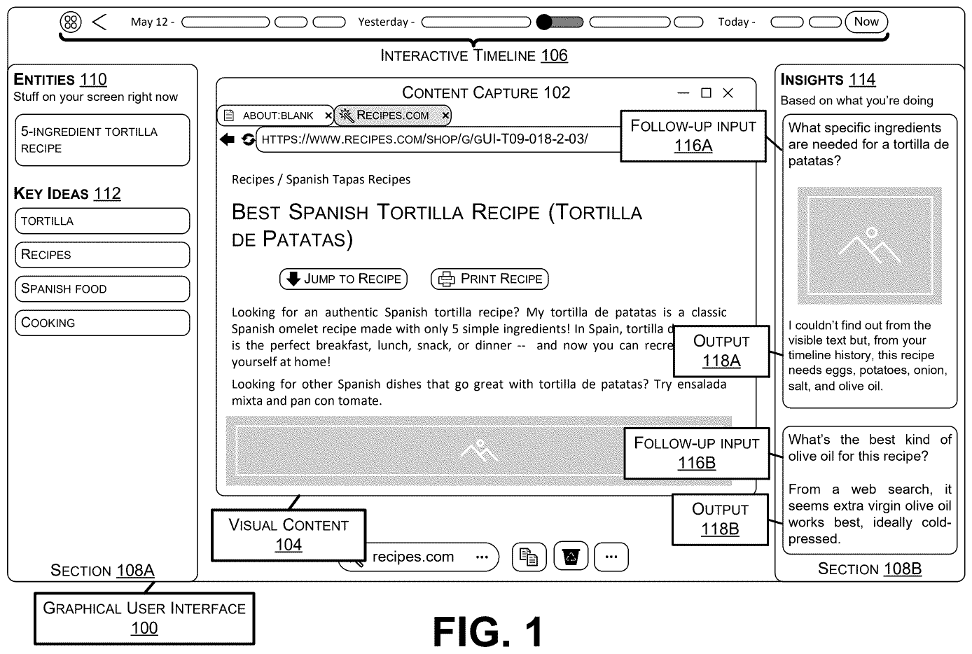

Various examples, scenarios, and aspects related to the techniques are described below with respect to FIGS. 1-6.

FIG. 1 illustrates a graphical user interface 100 for viewing and/or interacting with a content capture 102. In a specific example, the graphical user interface 100 is part of an activity recall application that periodically collects, with the consent of the user, a record of user activity to build a searchable repository of the user's activity history. As mentioned above, the content capture 102 records a specific moment of interest in a user's interaction with a computing device (e.g., a laptop, a tablet, a smartphone). In various examples, the content capture 102 is a composite of visual content 104 retrieved from one or more application windows within the desktop environment. Moreover, the visual content can comprise text content, image content, audio content, multimedia content, and the like. In the present example, the content capture 102 depicts a website (“Recipes.com”) for a Spanish tortilla (“Tortilla de Patatas”) comprising text content and image content.

In various examples, the graphical user interface 100 includes an interactive timeline 106 comprising a plurality of segments. Individual segments of the plurality of segments can represent periods of substantially continuous interaction with an associated software application, user activity, and/or piece of content. For instance, a user may read an article in a web browser (which is recorded in a first content capture) then switch to a messaging application to share the article with a friend (which is recorded in a second content capture). Accordingly, the interactive timeline 106 can render a first segment corresponding to the first content capture and a second segment corresponding to the second content capture. In addition, the lengths of each segment can be based on a length of time the user spent in the corresponding interaction. For instance, if the user spent fifteen minutes reading the article and thirty seconds sharing the article with their friend the first segment will be rendered with a greater visual length in relation to the second segment.

Furthermore, the graphical user interface 100 includes a section 108A that displays a rendering of a list of entities 110 in the visual content 104 and key ideas 112 which correspond to the semantic content conveyed by the visual content 104. In various examples, the visual content 104 of the content capture 102 is parsed by a content parsing tool such as optical character recognition (OCR) for extracting text content. In this way, the system can identify the entities 110 that are present in the content capture 102. Stated another way, the visual content 104 is extracted from the content capture 102 in a manner that is compatible with computational models such as AI systems. In another example, image content within the content capture 102 is parsed by an embedding model to reformat the image content for compatibility with computational models.

Accordingly, the computational model can identify key ideas 112 from the visual content 104. Stated another way, the computational model identifies the semantic content captured by the visual content 104. The semantic content of the content capture 102 is the inherent meaning conveyed by the visual content 104 (e.g., text content, image content). For instance, a string of text from the content capture 102 that reads “Spanish tortilla recipe” relates to more nebulous concepts such as “tortilla”, “recipes”, “Spanish food”, and “cooking”. That is, a concrete piece of visual content communicates semantic content that a reader (e.g., a human being) can infer and understand but which an automated tool that merely parses the visual content (e.g., OCR) cannot. As such, the system can leverage the strong language processing performance of modern computational models (e.g., large language models, small language models, multimodal generative AI models) to form associations between visual content and semantic content.

Consequently, the computational model proceeds to output various contextual insights 114 based on the semantic content identified from the visual content 104 of the content capture 102. These contextual insights 114 are rendered in another section 108B of the graphical user interface 100. For example, the computational model may identify that the recipe for tortilla de patatas depicted in the content capture 102 is “made with only 5 simple ingredients!” Logically, one may wonder what five ingredients are needed. Accordingly, the computational model produces a follow-up input 116A asking, “what specific ingredients are needed for a tortilla de patatas?”. In response, the computational model also produces an output 118A that corresponds to the follow-up input 116A stating “from your timeline history, this recipe needs eggs, potatoes, onion, salt, and olive oil.”. In an alternative example, the list of ingredients can be retrieved from a portion of the webpage that is not visible in the content capture 102. As mentioned above, the content capture 102 may include visual content 104 that is not directly visible on screen. For instance, a user may be viewing a webpage that extends past the bounds of the display of their computing device (e.g., a laptop screen). Nonetheless, the computing device has retrieved the full webpage when the user navigates to the webpage. Consequently, the content capture 102 can include the full visual content of the webpage (e.g., an extended screenshot).

In various examples, the information in the follow-up input 116A and/or the output 118A is sourced based on a web search and/or the user's past activity (e.g., other content captures, prior computation model queries and/or user feedback thereon). Moreover, the output 118A can include an indication and/or rendering of an information source to enable the user to further understand and/or verify the information. In addition, it should be understood that, while the sections 108A and 108B and illustrated as vertically oriented on the left and right sides of the graphical user interface 100, the sections 108A and 108B can be rendered in any suitable manner (e.g., horizontally oriented on the top and/or bottom of the graphical user interface 100).

Furthermore, the computational model can generate a second follow-up input 116B that semantically follows from the first follow-up input 116A. For instance, once one knew that the recipe needs “eggs, potatoes, onion, salt, and olive oil” the next logical step can be to investigate different types of ingredients. In the present example, the next follow-up input 116B is “what's the best kind of olive oil for this recipe?”. Similar to the above output 118A, the output 118B corresponding to the follow-up input 116B sources information from a web search stating, “it seems extra virgin olive oil works best, ideally cold-pressed.” Often referred to as chain-of-thought, the follow-up inputs 116A and 116B are calculated by the computational model as a series of semantically related statements that follow from one another. In various examples, the computational model may calculate several candidate outputs and accordingly select a top number (e.g., top five) that are the most semantically logical.

As mentioned above, the entities 110, key ideas 112, and subsequent insights 114 are output by the computational model automatically in response to the user viewing the content capture 102. That is, the user does not need to provide an explicit command and/or engage in additional technical operations to receive the additional information. In this way, the user can take advantage of modern computational models for streamlining information gathering and processing while reducing the friction and technical barrier to entry that often accompany such utilities.

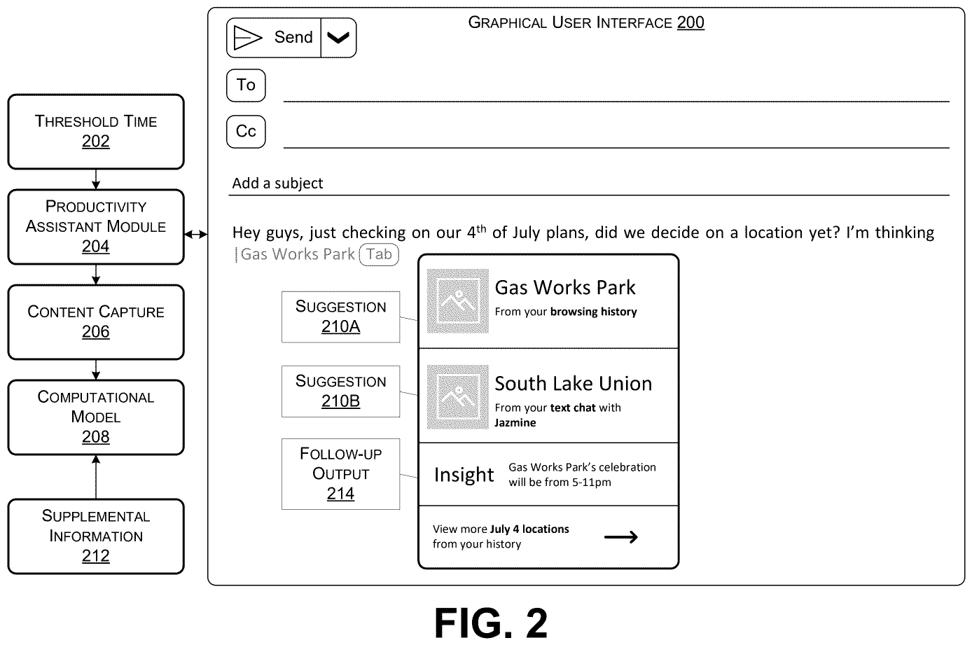

Turning now to FIG. 2, aspects of another example graphical user interface 200 are shown and described. In this example, the graphical user interface 200 is part of an email client application in which a user is currently composing an email. As shown, the user is inquiring as to the location for a 4^{th} of July holiday gathering as well as providing a suggestion of their own. Moreover, the user has paused their typing while considering a suitable location to suggest for the gathering. After a threshold amount of time 202 (e.g., five seconds) a productivity assistant module 204 extracts a content capture 206 of the visual content of the graphical user interface 200 and invokes a computational model 208 to provide suggestions and/or insights. In various examples, invoking the computational model 208 comprises executing the computational operations for generating the suggestions and/or insights prior to rendering the corresponding user interface elements.

Accordingly, the computational model 208 can identify certain semantic concepts (e.g., key ideas) based on the text content of the content capture 206 such as “4^{th} of July plans” and “location”. The computational model 208 can then generate and display suggestions 210A and 210B based on various factors such as the current location of the user and the past activity of the user. For example, the computational model 208 can be fed supplemental information 212 indicating that the user is based in Seattle as well as additional content captures of past activity related to “4^{th} of July plans”. Consequently, the suggestions 210A and 210B are generated within the context of the supplemental information 212 specifying locations within Seattle (e.g., Gas Works Park and South Lake Union). Stated another way, the supplemental information 212 enables the computational model 208 to provide suggestions 210A and 210B that are relevant to the user. For instance, while Elysian Park in New York City is a valid location for a 4^{th} of July gathering, it would not make sense to suggest Elysian Park to a user based in Seattle, unless other information was known about the user's intent to travel to New York City for the 4^{th} of July.

In addition, the rendering of the suggestions 210A and 210B includes an indication of the information source that informed the suggestions 210A and 210B. For example, the suggestion 210A (“Gas Works Park”) was informed by the user's online browsing history (e.g., web searches). In another example, the suggestion 210B was drawn from the user's text chat with a contact (“Jazmine”). In various examples, the information source indicated in the rendering of the suggestions 210A and 210B is captured in the supplemental information 212 containing related content captures, text documents, and the like. Like the examples described above, the suggestions 210A and 210B can be top ranked selections from a plurality of candidate suggestions that the computational model 208 determines have the highest probability of relevance and/or utility.

Furthermore, the computational model 208 can generate a follow-up output 214 that logically follows from the suggestions 210A and 210B. For example, the suggestion 210A names Gas Works Park as a suitable location for the 4^{th} of July gathering. As such, a logical follow-up to the suggestion 210A would be to research what time the 4^{th} of July celebration is at Gas Works Park. Similar to the chain-of-thought mentioned above with respect to FIG. 1, the follow-up output 214 aims to save the user time that would otherwise be spent searching and/or retrieving information thereby streamlining the user experience. Indeed, by proactively invoking the computational model 208 and outputting the suggestions 210A and 210B and the follow-up output 214, the user does not need to exit their current activity (composing an email) and/or break their concentration. Moreover, the user does not need prior technical knowledge and/or to engage in specific operations to take advantage of the utility presented by the computational model.

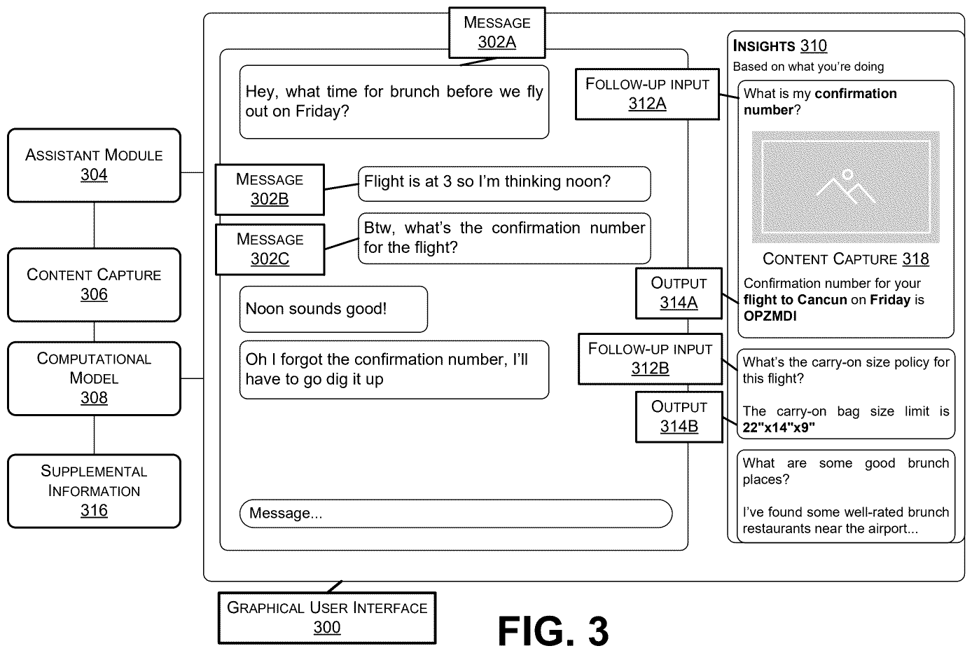

Turning now to FIG. 3, aspects of another graphical user interface 300 are shown and described. In the present example, a user is engaged in a text conversation comprising a plurality of messages 302A-302C discussing brunch plans prior to a flight. As shown, the user asks for a confirmation number for their flight in the message 302C. In various examples, an assistant module 304 may detect that the user has asked a question and extract a content capture 306 of the graphical user interface 300 depicting the text conversation. In addition, the assistant module 304 invokes a computational model 308 and inputs the content capture 306 for analysis. As described above, the computational model 308 can be a generative AI model (e.g., a large language model, a small language model, a multimodal generative AI model). Consequently, the computational model 306 identifies the semantic content present in the content capture 306 by processing the visual content (e.g., text content) according to the statistical relationships between individual tokens (e.g., words, characters) learned from large volumes of training data.

Generally described, a token is a lexical unit that serves as the fundamental unit of data that is processed by the computational model 308 and can be as granular as a single character (e.g., a letter, a number) up to the size of whole words and/or portions of words. As such, to enable the computational model 308 to “understand” the semantics of a given set of tokens, many systems utilize embeddings that convey the meaning, context, and/or relationships between the tokens (e.g., text embeddings, image embeddings, multimodal embeddings). In various examples, embeddings take the form of mathematical structures such as high-dimensional vectors.

Within the context of the present disclosure, the term “generative AI model” refers to a machine learning model that is employed to generate new content (e.g., text, images). One type of generative AI model is a “generative language model,” which is a model that can process natural language and/or generate new sequences of text given some input. One type of input for a generative language model is a natural language input, (e.g., a prompt potentially with some additional context). In various examples, a generative language model can be implemented as a neural network (e.g., a long short-term memory-based model, a decoder-based generative language model). Examples of decoder-based generative language models include versions of models such as GPT, BLOOM, PaLM, Mistral, Gemini, and/or LLaMA.

In some cases, a generative model can be multimodal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multimodal generative models where at least one mode of output includes natural language tokens. Likewise, the term “generative image model” encompasses multimodal generative models where at least one mode of output includes images or video. Examples of multimodal models include certain GPT variants such as GPT-4o, Gemini, Chameleon, etc. Multimodal models can also include lightweight models such as Phi-3-Vision-128K-Instruct.

A specific example of a generative language model is a large language model (LLM), which is a language model with many parameters (e.g., hundreds of millions of parameters, billions of parameters). Consequently, large language models possess high processing power and are likewise highly resource intensive, oftentimes demanding large-scale datacenters to operate. In comparison, a small language model (SLM) generally contains fewer parameters than a large language model (e.g., millions of parameters). As such, small language models are comparatively narrower in scope and scale and can thus be installed and executed on an end user device (e.g., a laptop, a smartphone).

Accordingly, the computational model 308 identifies the semantic content of the content capture 306 comprising the concepts the user is discussing such as “brunch”, a “flight on Friday”, and a “confirmation number”. In response, the computational model 308 produces a plurality of insights 310 comprising follow-up inputs 312A and 312B and corresponding outputs 314A and 314B containing information that is relevant to the user's present context. That is, the semantic content identified by the computational model 308 establishes the context within which the computational model 308 produces the follow-up inputs 312A and 312B and the corresponding outputs 314A and 314B.

For instance, the first follow-up input 312A is a query asking, “what is my confirmation number?” to which the corresponding output 314A states that the “confirmation number for your flight to Cancun on Friday is OPZMDI.” In this way, the computational model 308 anticipates the user's need to search for their confirmation number thereby saving the user time and effort. Similar to the examples discussed above, the computational model 308 produces the follow-up input 312A and corresponding output 314A utilizing various pieces of supplemental information such as past content captures, browsing history, computational model queries and/or feedback, calendar events, emails, and so forth. In the present example, the output 314A includes a rendering of a content capture 318 showing the source of the information reflected in the output 314A. For example, the content capture 318 can depict an email receipt of the user's flight that includes the confirmation number.

In addition, the follow-up input 312B can be a statement and/or query that logically follows from the first follow-up input 312A. For instance, once an individual has retrieved their flight confirmation number a logical next step would be to check rules regarding the size of carry-on luggage. Accordingly, the second follow-up input 312B inquires as to “the carry-on size policy for this flight?” To which the computational model 308 produces the corresponding output 314B stating that “the carry-on bag size limit is 22″×14″×9″.” In this way, the computational model 308 anticipates and proactively retrieves information that the user may need thereby reducing friction in the user experience.

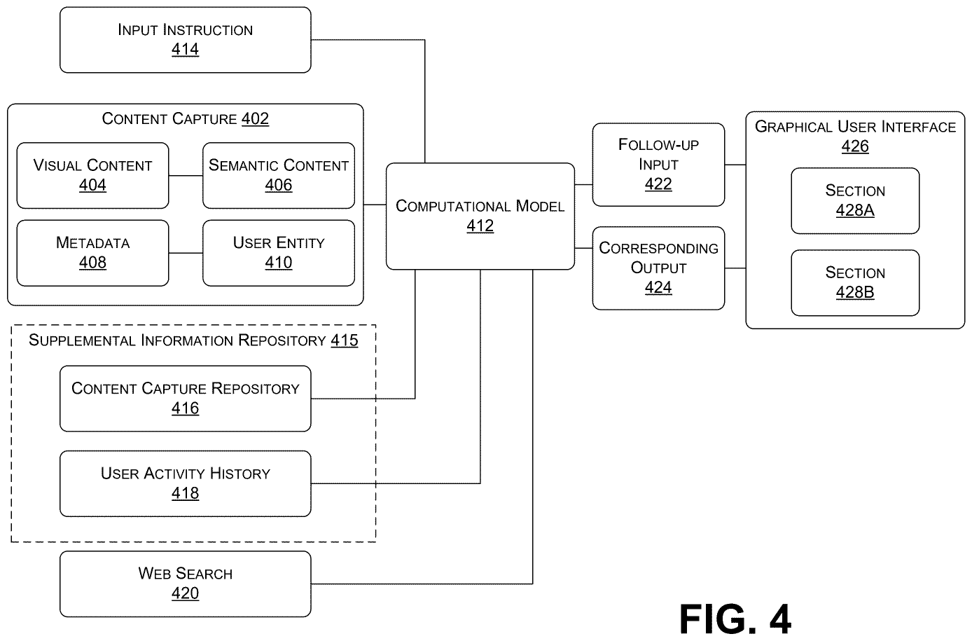

Turning now to FIG. 4, aspects of a system for providing contextual insights for a content capture 402 are shown and described. As mentioned above, the content capture 402 records a specific moment of interest in a user's interaction with a computing device (e.g., a laptop, a tablet, a smartphone). Accordingly, the content capture 402 includes a depiction of the visual content 404 that was present at the moment of interest. In some examples, the content capture 402 includes visual content 404 that was displayed on-screen. Alternatively, or additionally, the content capture 402 may include visual content 404 that was not directly visible on screen. For instance, a user may be viewing a webpage that extends past the bounds of the display of their computing device (e.g., a laptop screen). Nonetheless, the computing device or an application (e.g., browser) thereon has retrieved the full webpage when the user navigated to the webpage. Consequently, the content capture can include the full visual content 404 of the webpage (e.g., an extended screenshot).

In this way, the content capture 402 records semantic content 406 that is conveyed by the visual content 404. For instance, in the above examples, a webpage of a recipe for a Spanish tortilla (e.g., the visual content 404) serves to communicate a general and/or more nebulous concept such as Spanish cuisine, cooking technique, or the like that a human reader can glean.

In a specific example, the content capture 402 is generated as part of an activity recall application as shown in FIG. 1. In another example, the content capture 402 is generated during a user activity (e.g., a text conversation, composing an email), such as in response to an invocation of a productivity assistant as shown in FIGS. 2 and 3. In addition, the content capture 402 includes metadata 408 describing various aspects of the content capture such as a filename, a timestamp specifying when the content capture 402 was generated, and a user entity 410 associated with the content capture 402 (e.g., a user account, a username). Consequently, the metadata 408 enables downstream utility such as the personalized insights described above, a searchable activity history, and other such features.

The content capture 402 is then input to a computational model 412, such as the computational models discussed above with respect to FIGS. 1, 2, and/or 3, which processes the visual content 404 to identify the semantic content 406. In various examples, the computational model 412 is a generative AI model (e.g., a large language model, a small language model, a multimodal generative AI model). Generally described, a generative AI model refers to a machine learning model that is utilized to generate new content (e.g., text, images). In some examples, the computational model 412 can be multimodal. For instance, a computational model 412 with multimodal functionality is capable of using various combinations of text, images (e.g., the content capture 402), video, audio, application states, code, or other modalities as inputs and/or generating combinations of text, images, video, audio, application states, or code or other modalities as outputs.

Moreover, the computational model 412 produces output based on training obtained from large volumes of data during which the computational model 412 learns the statistical relationships between individual tokens (e.g., individual words, individual characters). In addition, the computational model 412 produces output in accordance with an input instruction 414 (e.g., a text generation prompt). In the context of the present disclosure, the input instruction 414 is an input that causes the computational model 412 to execute a specified task using a natural language input, in some cases with additional context (e.g., supplemental information). For example, the input instruction 414 can be a command stating, “analyze the content capture and come up with follow-up insights using the supplemental information provided.” Within the context of the present disclosure, the input instruction 414 is automatically generated and/or preconfigured as part of a software package that is released to the end user device. That is, the end user does not instruct the computational model 412 themselves. As mentioned above, the system is configured to anticipate the information an end user may need at a given time and proactively provide contextual insights without requiring the user to engage in specific technical operations.

Accordingly, the computational model 412 can retrieve supplemental information from a supplemental information repository 415 that includes a content capture repository 416 and/or a user activity history 418 associated with the user entity 410 as well as source information via a web search 420. In one example, the computational model 412 can retrieve preexisting content captures containing visual content that are semantically related to the content capture 402. That is, the semantic content of the preexisting content captures is related to the semantic content 406 of the content capture 402. For instance, consider a content capture 402 in which the visual content 404 communicates a recipe for homemade pizza dough that instructs the user to use their preferred flour. Consequently, the user may proceed to look up different types of flour such as all-purpose flour, bread flour, and whole grain flour. This subsequent search is recorded in another content capture stored in the content capture repository 416.

As such, when the user returns to the content capture 402 at a later point in time, the computational model 412 determines that the content capture stored in the content capture repository 416 is semantically related to the present content capture 402. In response, the computational model 412 retrieves the other content capture to use as supplemental information. In another example, the computational model 412 can retrieve some or all of a user activity history 418 similar to the content capture repository 416. The user activity history can include available user files (e.g., text documents, images, messages), internet browser history, computational model queries and/or feedback, and the like. In this way, the computational model 412 can obtain contextual information that enables outputs that are customized to an end user's specific context.

Accordingly, the output of the computational model 412 comprises a follow-up input 422 (e.g., a question, a query) and/or a corresponding output 424 (e.g., an answer) such as those discussed above with respect to FIGS. 1-3. Generally described, the follow-up input 422 is an input to the computational model 412 that logically follows from the semantic content 406 of the content capture 402 being analyzed and causes the computational model 412 to produce the corresponding output 424. For instance, returning to the example of homemade pizza dough, a reasonable follow-up input 422 may be a question asking, “what is the best flour for homemade pizza dough?” to which the corresponding output 424 can be “use all-purpose flour for a crispy crust but use bread flour for a chewy crust.”

As mentioned above, the computational model 412 can generate a plurality of candidates for the follow-up input 422 which are then ranked according to the likelihood of their semantic relevance to the content capture 402 and the context provided by the content capture repository 416 and/or the user activity history 418. In various examples, the ranking is calculated by the computational model 412 in accordance with the statistical relationships it learned during training as well as subsequent finetuning and/or user feedback. For instance, a user may mark a follow-up input 422 as “not useful” which can then serve as feedback to finetune the computational model 412 for subsequent outputs.

Finally, the follow-up input 422 and the corresponding output 424 are rendered in a graphical user interface 426. As described above, the follow-up input 422 and the corresponding output 424 are rendered in a specific section 428A of the graphical user interface 426 such as a sidebar that is displayed concurrently with the visual content 404. In addition, the semantic content 406 identified by the computational model 412 can be rendered in a second section 428B of the graphical user interface to provide further context to the follow-up input 422 and/or the corresponding output 424. In this way, the graphical user interface 426 provides a seamless user experience that enables the user to receive and/or interact with contextual insights without shifting focus away from their current activity.

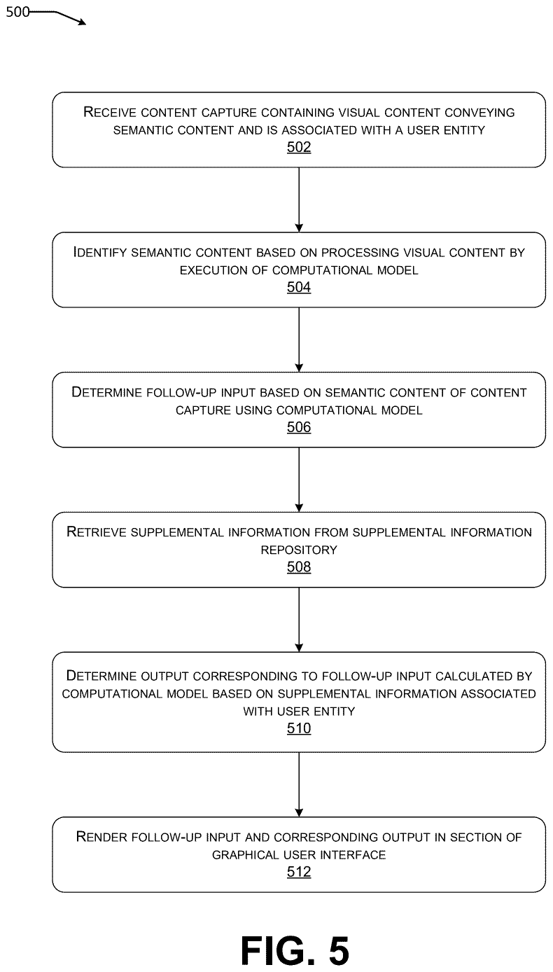

Turning now to FIG. 5, aspects of a routine 500 for providing contextual insights for a content capture in a graphical user interface are shown and described. With respect to FIG. 5, the process 500 begins at operation 502 in which the system receives a content capture containing visual content conveying a semantic content of the content capture. That is, while the visual content comprises concrete visual objects such as text, images, and/or other content, the semantic content comprises more nebulous and/or vague concepts that a human reader may glean from a viewing of the visual content. For instance, a recipe is merely a collection of text and/or images that must be semantically processed (e.g., by a human, by a computational model) in order to have any meaning (e.g., aspects of a cuisine, cooking techniques).

Next, at operation 504, the system identifies the semantic content of the content capture by executing a computational model to process the visual content. As discussed above, the computational model can be an artificial intelligence model such as a small language model, a large language model, or a multimodal generative AI model. For instance, the system can take advantage of the strong natural language processing performance of language models to identify the concepts being communicated by the visual content. However, it should be understood that the computational model can be implemented in any suitable manner such as a neural network (e.g., a long short-term memory-based model, a decoder-based language model). Examples of decoder-based language models include versions of models such as GPT, BLOOM, PaLM, Mistral, Gemini, and/or LLaMA. Accordingly, the computational model can be trained to predict tokens in sequences of textual training data. When employed in inference mode, the output of the computational model can include new sequences of text that the model generates (e.g., a follow-up input). Moreover, the computational model can be executed offline (e.g., on the end user's computing device) and/or online (e.g., via a cloud computing service).

Then, at operation 506, the computational model determines a follow-up input based on the semantic content of the content capture. As described above, the follow-up input is a natural language input (e.g., a query, a question, a statement) that logically follows from the semantic content depicted in the content capture. For instance, consider a content capture depicting a recipe for a homemade pizza dough. A natural follow-up that one may have when reading the recipe may be “what is the best flour to use for pizza dough?” Accordingly, the computational model anticipates such continuations via the follow-up inputs it generates.

Subsequently, at operation 508, the computational model retrieves supplemental information from a supplemental information repository. As discussed above, the supplemental information can include additional content captures that are semantically related to the current content capture and/or a user activity history. In this way, the supplemental information provides context to the computational model which enables specific and/or relevant insights that are tailored to the user's needs.

Next, at operation 510, the computational model determines an output corresponding to the follow-up input wherein the computational model is configured to calculate the output based on supplemental information associated with the user entity. That is, the computational model processes the follow-up input to produce a natural language output (e.g., a search result, an answer to a question). In various examples, the computational model retrieves supplemental information such as semantically related content captures, the user's activity history, prior computational model queries and/or user feedback, and/or web search results to serve as context when calculating the output. For instance, returning to the example of a homemade pizza dough recipe, the computational model may retrieve a content capture recording a web search for different types of flour that the user performed. Accordingly, the computational model can determine that the user is likely interested in the effect of different types of flour on pizza dough. Consequently, the output corresponding to “what is the best flour to use for pizza dough?” can be “use all-purpose flour for a crispy crust but use bread flour for a chewy crust.”

Finally, at operation 512, the system renders the follow-up input and the corresponding output in a section of a graphical user interface. In one example, the graphical user interface is part of a user activity recall application in which the user can view and/or interact with individual content captures such as the example shown in FIG. 1. Accordingly, the follow-up input and the corresponding output are rendered alongside the content capture to provide the user relevant information within the context of the content capture. In another example, the graphical user interface is part of an email application in which the user is composing a message such as the example shown in FIG. 2. In this example, the follow-up input and the corresponding output can be rendered as a series of suggestions inline with the text of the user's email. In still another example, the graphical user interface is part of a chat application in which a user is engaged in conversation as shown in FIG. 3 in which the user can receive insights on the topics currently being discussed. In this way, the system provides insights for onscreen content without requiring the user to break their focus on their current activity to search and/or retrieve information.

The particular implementation of the technologies disclosed herein is a matter of choice depending on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice depending on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

The particular implementation of the technologies disclosed herein is a matter of choice depending on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice depending on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

The particular implementation of the technologies disclosed herein is a matter of choice depending on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can begin and/or end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice depending on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 500 can be implemented, at least in part, by modules running the features disclosed herein can be a dynamically linked library, a statically linked library, functionality produced by an application programing interface, a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 500 may also be implemented in other ways. In addition, one or more of the operations of the process 500 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

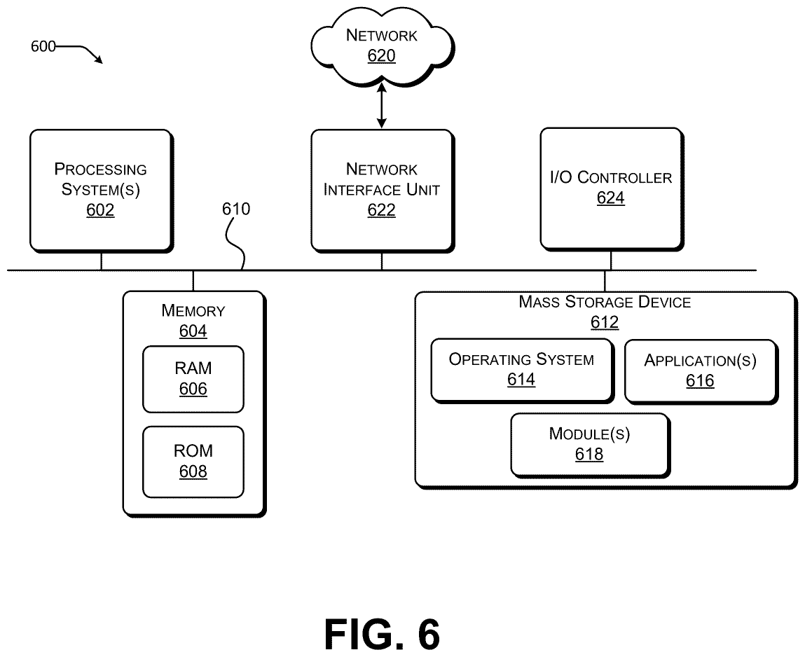

FIG. 6 shows additional details of an example computer architecture 600 for a device, capable of executing computer instructions (e.g., a module or a program component described herein). The computer architecture 600 illustrated in FIG. 6 includes processing system 602, a system memory 604, including a random-access memory 606 (RAM) and a read-only memory (ROM) 608, and a system bus 610 that couples the memory 604 to the processing system 602. The processing system 602 comprises processing unit(s). In various examples, the processing unit(s) of the processing system 602 are distributed. Stated another way, one processing unit of the processing system 602 may be located in a first location (e.g., a rack within a datacenter) while another processing unit of the processing system 602 is located in a second location separate from the first location. Moreover, the systems discussed herein can be provided as a distributed computing system such as a cloud service.

Processing unit(s), such as processing unit(s) of processing system 602, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 600, such as during startup, is stored in the ROM 608. The computer architecture 600 further includes a mass storage device 612 for storing an operating system 614, application(s) 616, modules 618, and other data described herein.

The mass storage device 612 is connected to processing system 602 through a mass storage controller connected to the bus 610. The mass storage device 612 and its associated computer-readable media provide non-volatile storage for the computer architecture 600. Although the description of computer-readable media contained herein refers to a mass storage device, the computer-readable media can be any available computer-readable storage media or communication media that can be accessed by the computer architecture 600.

Computer-readable media includes computer-readable storage media and/or communication media. Computer-readable storage media includes one or more of a volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 600 may operate in a networked environment using logical connections to remote computers through the network 620. The computer architecture 600 may connect to the network 620 through a network interface unit 622 connected to the bus 610. The computer architecture 600 also may include an input/output controller 624 for receiving and processing input from a number of other devices, including a keyboard, mouse, touch, or electronic stylus or pen. Similarly, the input/output controller 624 may provide output to a display screen, a printer, or other type of output device.

The software components described herein may, when loaded into the processing system 602 and executed, transform the processing system 602 and the overall computer architecture 600 from a general-purpose computing system into a special-purpose computing system customized to facilitate the functionality presented herein. The processing system 602 may be constructed from any number of transistors or other discrete circuit elements, which may individually or collectively assume any number of states. More specifically, the processing system 602 may operate as a finite-state machine, in response to executable instructions contained within the software modules disclosed herein. These computer-executable instructions may transform the processing system 602 by specifying how the processing system 602 transition between states, thereby transforming the transistors or other discrete hardware elements constituting the processing system 602.

The disclosure presented herein also encompasses the subject matter set forth in the following clauses.
Example Clause A, a method for outputting contextual insights for a content capture in a graphical user interface, the method comprising: receiving the content capture, wherein: the content capture contains visual content conveying a semantic content of the content capture; and the content capture is associated with a user entity; identifying the semantic content based on a processing of the visual content by execution of a computational model; determining, by the computational model, a follow-up input based on the semantic content of the content capture; retrieving, by the computational model supplemental information from a supplemental information repository; determining, by the computational model, an output corresponding to the follow-up input, wherein the computational model is configured to determine the output corresponding to the follow-up input based on the supplemental information associated with the user entity; and rendering the follow-up input and the output corresponding to the follow-up input in a section of the graphical user interface.
Example Clause B, the method of Example Clause A, wherein the computational model is invoked in response to a detection of a user activity trigger.
Example Clause C, the method of Example Clause A or Example Clause B, wherein a generation of the follow-up input and the output corresponding to the follow-up input is initiated without a user-generated command.
Example Clause D, the method of any one of Example Clause A through C, wherein the supplemental information associated with the user entity is a preexisting content capture containing additional semantic content that is related to the semantic content of the content capture.
Example Clause E, the method of any one of Example Clause A through D, wherein: the section of the graphical user interface in which the follow-up input and the output corresponding to the follow-up input are rendered is a first section; and the method further comprises rendering the semantic content in a second section of the graphical user interface.
Example Clause F, the method of any one of Example Clause A through E, wherein the supplemental information includes a past activity associated with the user entity.
Example Clause G, the method of Example Clause F, wherein the section of the graphical user interface in which the follow-up input and the output corresponding to the follow-up input are rendered includes a rendering of at least a portion of the past activity that the follow-up input and the output corresponding to the follow-up input are based on.
Example Clause H, the method of any one of Example Clause A through G, wherein the output corresponding to the follow-up input includes information obtained in response to a web search of the follow-up input.
Example Clause I, the method of any one of Example Clause A through H, wherein the follow-up input comprises a chain-of-thought containing a sequence of semantically related statements.
Example Clause J, a system for outputting contextual insights for a content capture in a graphical user interface, the system comprising: a processing unit; and a computer-readable medium having encoded thereon computer-readable instructions that, when executed by the processing unit, cause the system to perform operations comprising: receiving the content capture wherein: the content capture contains visual content conveying a semantic content of the content capture; and the content capture is associated with a user entity; identifying the semantic content based on a processing of the visual content by execution of a computational model; determining, by the computational model, a follow-up input based on the semantic content of the content capture; retrieving, by the computational model supplemental information from a supplemental information repository; determining, by the computational model, an output corresponding to the follow-up input, wherein the computational model is configured to determine the output corresponding to the follow-up input based on the supplemental information associated with the user entity; and rendering the follow-up input and the output corresponding to the follow-up input in a section of the graphical user interface.
Example Clause K, the system of Example Clause J, wherein the computational model is invoked in response to a detection of a user activity trigger.
Example Clause L, the system of Example Clause J or Example Clause K, wherein a generation of the follow-up input and the output corresponding to the follow-up input is initiated without a user-generated command.
Example Clause M, the system of any one of Example Clause J through L, wherein the supplemental information associated with the user entity is a preexisting content capture containing additional semantic content that is related to the semantic content of the content capture.
Example Clause N, the system of any one of Example Clause J through M, wherein: the section of the graphical user interface in which the follow-up input and the output corresponding to the follow-up input are rendered is a first section; and the method further comprises rendering the semantic content in a second section of the graphical user interface.
Example Clause O, the system of any one of Example Clause J through N, wherein the supplemental information includes a past activity associated with the user entity.
Example Clause P, the system of Example Clause O, wherein the section of the graphical user interface in which the follow-up input and the output corresponding to the follow-up input are rendered includes a rendering of at least a portion of the past activity that the follow-up input and the output corresponding to the follow-up input are based on.
Example Clause Q, the system of any one of Example Clause J through P, wherein the output corresponding to the follow-up input includes information obtained in response to a web search of the follow-up input.
Example Clause R, the system of any one of Example Clause J through Q, wherein the follow-up input comprises a chain-of-thought containing a sequence of semantically related statements.
Example Clause S, a computer-readable storage medium for outputting contextual insights for a content capture in a graphical user interface, the computer-readable storage medium having computer-readable instructions encoded thereon that, when executed by a system, causes the system to perform operations comprising: receiving the content capture, wherein: the content capture contains visual content conveying a semantic content of the content capture; and the content capture is associated with a user entity; identifying the semantic content based on a processing of the visual content by execution of a computational model; determining, by the computational model, a follow-up input based on the semantic content of the content capture; retrieving, by the computational model supplemental information from a supplemental information repository; determining, by the computational model, an output corresponding to the follow-up input, wherein the computational model is configured to determine the output corresponding to the follow-up input based on the supplemental information associated with the user entity; and rendering the follow-up input and the output corresponding to the follow-up input in a section of the graphical user interface.
Example Clause T, the computer-readable storage medium of Example Clause S, wherein the computational model is invoked in response to a detection of a user activity trigger.

Conditional language such as, among others, “can,” “could,” “might” or “may,” unless specifically stated otherwise, are understood within the context to present that certain examples include, while other examples do not include, certain features, elements, and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for outputting contextual insights for a content capture in a graphical user interface, the method comprising:
receiving the content capture, wherein:
the content capture contains visual content conveying a semantic content of the content capture; and
the content capture is associated with a user entity;
identifying the semantic content based on a processing of the visual content by execution of a computational model;
determining, by the computational model, a follow-up input based on the semantic content of the content capture;
retrieving, by the computational model supplemental information from a supplemental information repository;
determining, by the computational model, an output corresponding to the follow-up input, wherein the computational model is configured to determine the output corresponding to the follow-up input based on the supplemental information associated with the user entity; and
rendering the follow-up input and the output corresponding to the follow-up input in a section of the graphical user interface.

2. The method of claim 1, wherein the computational model is invoked in response to a detection of a user activity trigger.

3. The method of claim 1, wherein a generation of the follow-up input and the output corresponding to the follow-up input is initiated without a user-generated command.

4. The method of claim 1, wherein the supplemental information associated with the user entity is a preexisting content capture containing additional semantic content that is related to the semantic content of the content capture.

5. The method of claim 1, wherein:
the section of the graphical user interface in which the follow-up input and the output corresponding to the follow-up input are rendered is a first section; and
the method further comprises rendering the semantic content in a second section of the graphical user interface.

6. The method of claim 1, wherein the supplemental information includes a past activity associated with the user entity.

7. The method of claim 6, wherein the section of the graphical user interface in which the follow-up input and the output corresponding to the follow-up input are rendered includes a rendering of at least a portion of the past activity that the follow-up input and the output corresponding to the follow-up input are based on.

8. The method of claim 1, wherein the output corresponding to the follow-up input includes information obtained in response to a web search of the follow-up input.

9. The method of claim 1, wherein the follow-up input comprises a chain-of-thought containing a sequence of semantically related statements.

10. A system for outputting contextual insights for a content capture in a graphical user interface, the system comprising:
a processing unit; and
a computer-readable medium having encoded thereon computer-readable instructions that, when executed by the processing unit, cause the system to perform operations comprising:
receiving the content capture wherein:
the content capture contains visual content conveying a semantic content of the content capture; and
the content capture is associated with a user entity;
identifying the semantic content based on a processing of the visual content by execution of a computational model;
determining, by the computational model, a follow-up input based on the semantic content of the content capture;
retrieving, by the computational model supplemental information from a supplemental information repository;
determining, by the computational model, an output corresponding to the follow-up input, wherein the computational model is configured to determine the output corresponding to the follow-up input based on the supplemental information associated with the user entity; and
rendering the follow-up input and the output corresponding to the follow-up input in a section of the graphical user interface.

11. The system of claim 10, wherein the computational model is invoked in response to a detection of a user activity trigger.

12. The system of claim 10, wherein a generation of the follow-up input and the output corresponding to the follow-up input is initiated without a user-generated command.

13. The system of claim 10, wherein the supplemental information associated with the user entity is a preexisting content capture containing additional semantic content that is related to the semantic content of the content capture.

14. The system of claim 10, wherein:
the section of the graphical user interface in which the follow-up input and the output corresponding to the follow-up input are rendered is a first section; and
the method further comprises rendering the semantic content in a second section of the graphical user interface.

15. The system of claim 10, wherein the supplemental information includes a past activity associated with the user entity.

16. The system of claim 15, wherein the section of the graphical user interface in which the follow-up input and the output corresponding to the follow-up input are rendered includes a rendering of at least a portion of the past activity that the follow-up input and the output corresponding to the follow-up input are based on.

17. The system of claim 10, wherein the output corresponding to the follow-up input includes information obtained in response to a web search of the follow-up input.

18. The system of claim 10, wherein the follow-up input comprises a chain-of-thought containing a sequence of semantically related statements.

19. A computer-readable storage medium for outputting contextual insights for a content capture in a graphical user interface, the computer-readable storage medium having computer-readable instructions encoded thereon that, when executed by a system, causes the system to perform operations comprising:
receiving the content capture, wherein:
the content capture contains visual content conveying a semantic content of the content capture; and
the content capture is associated with a user entity;
identifying the semantic content based on a processing of the visual content by execution of a computational model;
determining, by the computational model, a follow-up input based on the semantic content of the content capture;
retrieving, by the computational model supplemental information from a supplemental information repository;
determining, by the computational model, an output corresponding to the follow-up input, wherein the computational model is configured to determine the output corresponding to the follow-up input based on the supplemental information associated with the user entity; and
rendering the follow-up input and the output corresponding to the follow-up input in a section of the graphical user interface.

20. The computer-readable storage medium of claim 19, wherein the computational model is invoked in response to a detection of a user activity trigger.
